(19) United States
(12) Patent Application Publication
(10) Pub. No.: US 2025/0027914 A1
(43) Pub. Date: Jan. 23, 2025

(54) ANALYSIS DEVICE AND GAIN ADJUSTMENT DEVICE

(71) Applicant: SHIMADZU CORPORATION, Kyoto (JP)

(72) Inventor: Hiroshi TANAKA, Kyoto (JP)

(73) Assignee: SHIMADZU CORPORATION, Kyoto (JP)

(21) Appl. No.: 18/776,313

(22) Filed: Jul. 18, 2024

(30) Foreign Application Priority Data
Jul. 20, 2023 (JP) 2023-118670

(51) Int. Cl. G01N 30/74; G01N 30/02; G01N 30/86

(52) U.S. Cl. CPC G01N 30/74; G01N 30/8658; G01N 2030/027

(57) ABSTRACT

A high performance liquid chromatograph includes a photomultiplier tube that detects fluorescence generated from a sample and a gain adjustment device that adjusts a gain of the photomultiplier tube. The gain adjustment device includes an acquirer that acquires a detection value of fluorescence detected by the photomultiplier tube, a power supply that supplies power to the photomultiplier tube, and a power supply controller that adjusts a gain of the photomultiplier tube in one analysis for a sample by controlling the power supply in accordance with the detection value acquired by the acquirer.

### BACKGROUND

### Technical Field

The present disclosure relates to a gain adjustment device that adjusts a gain of a fluorescence detector, and an analysis device including the gain adjustment device.

### Description of Related Art

There is a fluorescence detector used as a detector in a high performance liquid chromatograph. A photomultiplier tube used in the fluorescence detector can detect weak light with high sensitivity.

In a case in which the concentration of a sample is high, a fluorescence intensity is high, and the output of the photomultiplier tube may be saturated. Therefore, in a case in which the concentration of a sample is high, it is necessary to avoid saturation of output by reducing a gain of the photomultiplier tube. On the other hand, in a case in which the concentration of a sample is low, it is necessary to increase a gain of the photomultiplier tube such that a signal caused by a component is not buried in a noise of an electric system or the like.

The high performance liquid chromatograph disclosed in JP 2020-526770 A includes a UV-VIS detector unit. The detector unit is configured to detect a reference beam that is not transmitted through a sample in the detector unit. Thus, variations in intensity of light output from a light source included in the detector unit is acquired.

### SUMMARY

For example, in impurity analysis by a chromatograph, it is necessary to analyze both a high-concentration main component and low-concentration impurities included in one sample. However, as described above, in a case in which a high-concentration component is analyzed, it is necessary to reduce a gain of a photomultiplier tube. In a case in which a low-concentration component is analyzed, it is necessary to increase a gain of a photomultiplier tube. Therefore, it was not possible to analyze these components at once. Therefore, a measure such as execution of an analysis with setting of a low gain without sensitivity or execution of two analyses measure with a changed gain is used.

An object of the present disclosure is to provide an analysis device capable of obtaining an appropriate measurement result using a fluorescence detector in accordance with a concentration of a component included in a sample.

An analysis device according to one aspect of the present disclosure includes a light source that excites a sample, a photomultiplier tube that detects fluorescence generated from the sample, and a gain adjustment device that adjusts a gain of the photomultiplier tube. The gain adjustment device includes an acquirer that acquires a detection value of fluorescence detected by the photomultiplier tube, a power supply that supplies power to the photomultiplier tube, and a power supply controller that adjusts a gain of the photomultiplier tube during one analysis for the sample by controlling the power supply of the photomultiplier tube in accordance with the detection value acquired by the acquirer.

A gain adjustment device according to another aspect of the present disclosure that adjusts a gain of a photomultiplier tube, includes an acquirer that acquires a detection value provided by the photomultiplier tube, a power supply that supplies power to the photomultiplier tube, and a power supply controller that adjusts a gain of the photomultiplier tube in one analysis for a sample by controlling the power supply in accordance with the detection value acquired by the acquirer.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is an overview of a high performance liquid chromatograph according to the present embodiment;

FIG. 2 is a block diagram of a fluorescence detector and a gain adjustment device according to the present embodiment;

FIG. 3 is a graph showing fluorescence intensities received by the photomultiplier tube;

FIG. 4 is a graph showing voltages to be applied to the photomultiplier tube;

FIG. 5 is a graph showing detection values output from the photomultiplier tube;

FIG. 6 is a graph showing detection values obtained after correction;

FIG. 7 is a graph showing detection values being saturated in a high-concentration area; and

FIG. 8 is a graph showing detection values being buried in a noise in a low-concentration area.

### DETAILED DESCRIPTION

A gain adjustment device and an analysis device including the gain adjustment device according to embodiments of the present disclosure will now be described with reference to the attached drawings.

### (1) Overall Configuration of Device

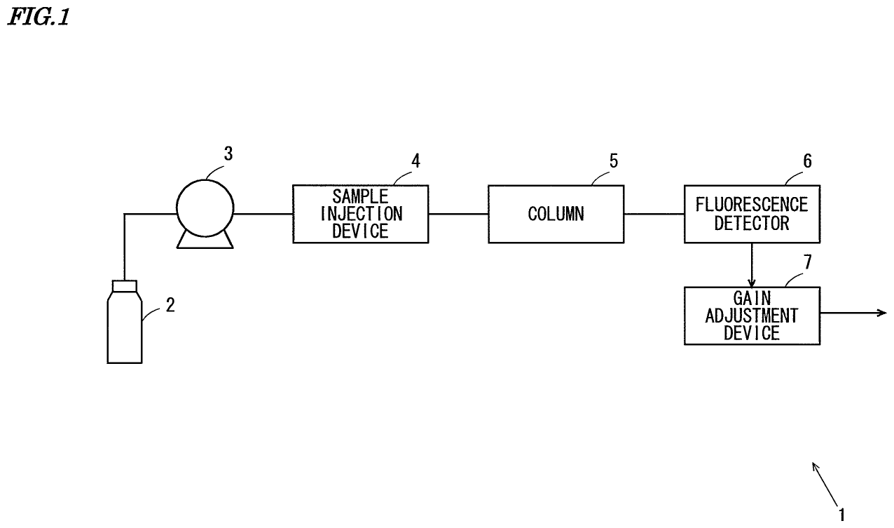

FIG. 1 is an overview showing a high performance liquid chromatograph according to the present embodiment. The high performance liquid chromatograph 1 includes a solvent supplier 2, a liquid sending pump 3, a sample injection device 4, a column 5, a fluorescence detector 6 and a gain adjustment device 7. The high performance liquid chromatograph 1 is an example of an analysis device of the present disclosure.

The solvent supplier 2 stores a solvent such as an aqueous solvent or an organic solvent. The liquid sending pump 3 supplies the solvent stored in the solvent supplier 2 to an analysis flow path as a mobile phase. The sample injection device 4 injects a sample into the solvent supplied to the analysis flow path. The solvent into which the sample has been injected is introduced into the column 5. In the column 5, the sample is separated into components based on the interaction between the mobile phase and a stationary phase. The sample separated in the column 5 is introduced into the fluorescence detector 6 together with the solvent. The fluorescence detector 6 irradiates the sample with excitation light and detects fluorescence generated from the sample using a photomultiplier tube. The gain adjustment device 7 adjusts a gain of the fluorescence detector 6. The gain adjustment device 7 also corrects a detection value of the fluorescence detector 6 according to the gain of the fluorescence detector 6.

### (2) Configuration of Fluorescence Detector

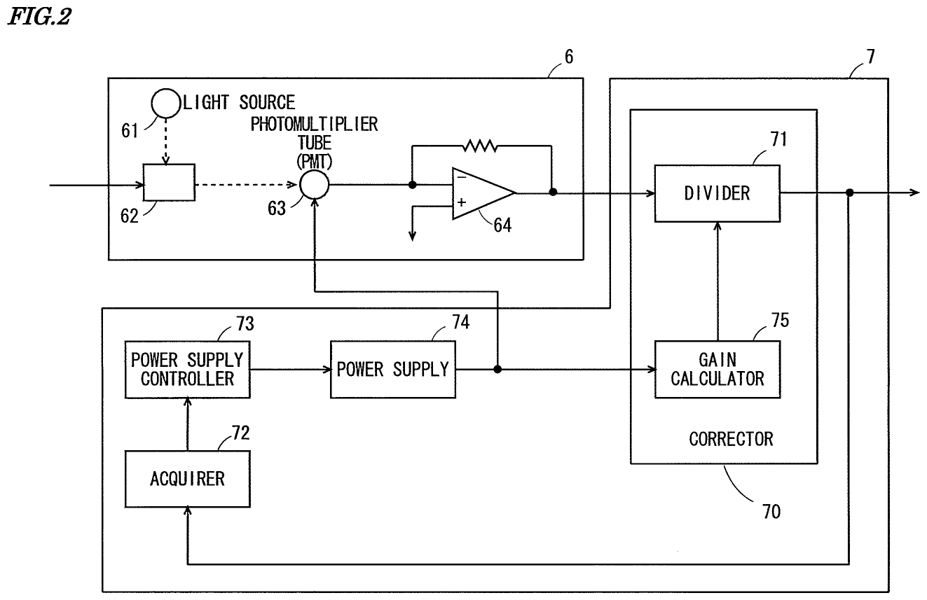

Next, the configuration of the fluorescence detector 6 will be described with reference to FIG. 2. As shown in FIG. 2, the fluorescence detector 6 includes a light source 61, a flow cell 62, the photomultiplier tube (PMT) 63 and a current-voltage conversion circuit 64.

The light source 61 irradiates a sample with excitation light. As the light source 61, a xenon lamp, a deuterium lamp or the like is used. The excitation light emitted from the light source 61 is extracted as excitation light having a specific wavelength by a spectrometer (not shown), and is emitted to the sample flowing through the flow cell 62.

The sample having a fluorescence emission property and flowing through the flow cell 62 is irradiated with excitation light, so that fluorescence is generated from the sample. Light having a specific wavelength is selected from the fluorescence generated from the sample by the spectrometer (not shown), and the selected light enters the photomultiplier tube 63.

The photomultiplier tube 63 receives the fluorescence generated from the sample and generates electrons corresponding to the intensity of light with the photoelectric effect. Then, the photomultiplier tube 63 amplifies the generated electrons so as to output a sample detection value as an electric signal.

The current-voltage conversion circuit 64 converts a current as the detection value output from the photomultiplier tube 63 into a voltage. The sample detection value that has been converted into the voltage in the current-voltage conversion circuit 64 is output to the gain adjustment device 7.

### (3) Configuration of Gain Adjustment Device

Next, the configuration of the gain adjustment device 7 will be described with reference to FIG. 2. As shown in FIG. 2, the gain adjustment device 7 includes a divider 71, an acquirer 72, a power supply controller 73, a power supply 74 and a gain calculator 75. A corrector 70 includes the divider 71 and the gain calculator 75.

The corrector 70 receives a sample detection value output from the fluorescence detector 6. The corrector 70 corrects the received detection value according to a value of gain (multiplication factor) of the photomultiplier tube 63. The corrector 70 outputs a corrected detection value as a sample measurement value.

The acquirer 72 receives the corrected detection value output from the corrector 70. The acquirer 72 provides the acquired corrected detection value to the power supply controller 73.

The power supply controller 73 controls the power supply 74. The power supply controller 73 controls the power supply 74 based on the corrected sample detection value acquired from the acquirer 72. The power supply 74 is a high-voltage power supply that supplies power to the photomultiplier tube 63.

In a case in which the corrected sample detection value is higher than a first threshold value, the power supply controller 73 provides an instruction for reducing a voltage to be applied to the photomultiplier tube 63 to the power supply 74. For example, the power supply controller 73 provides an instruction for reducing a currently applied voltage by a predetermined voltage to the power supply 74. In a case in which the corrected sample detection value is lower than a second threshold value, the power supply controller 73 provides an instruction for increasing a voltage to be applied to the photomultiplier tube 63 to the power supply 74. For example, the power supply controller 73 provides an instruction for increasing a currently applied voltage by a predetermined voltage to the power supply 74.

The gain calculator 75 acquires the voltage value of a voltage applied to the photomultiplier tube 63 by the power supply 74. The gain calculator 75 calculates a gain of the photomultiplier tube 63 based on the voltage value of a voltage being currently supplied by the power supply 74. The gain calculator 75 stores the relationship between a voltage applied to the photomultiplier tube 63 and a gain of the photomultiplier tube 63 in a table. The gain calculator 75 calculates a current gain of the photomultiplier tube 63 based on the stored table. The relationship between an applied voltage and a gain in the photomultiplier tube may vary depending on products. Therefore, the gain adjustment device 7 of the present embodiment stores the table in the storage device in advance, with the table being obtained under the condition that the photomultiplier tube 63 is attached to the fluorescence detector 6. This table may be provided at the time of shipment from a factory, or may be acquired by measurement in the high performance liquid chromatograph 1 including the fluorescence detector 6 and the gain adjustment device 7.

A gain of the photomultiplier tube can be expressed by the following formula.

μ=A·V^{kn}

In this formula, μ is a gain, V is an applied voltage, and A, k and n are constants that depend on a circuit or a device of the photomultiplier tube.

The divider 71 acquires a current gain of the photomultiplier tube 63 calculated by the gain calculator 75, and corrects a sample detection value based on the acquired gain. In the present embodiment, the divider 71 divides the detection value output from the fluorescence detector 6 by the gain, and outputs a corrected detection value.

### (4) Gain Adjustment Method

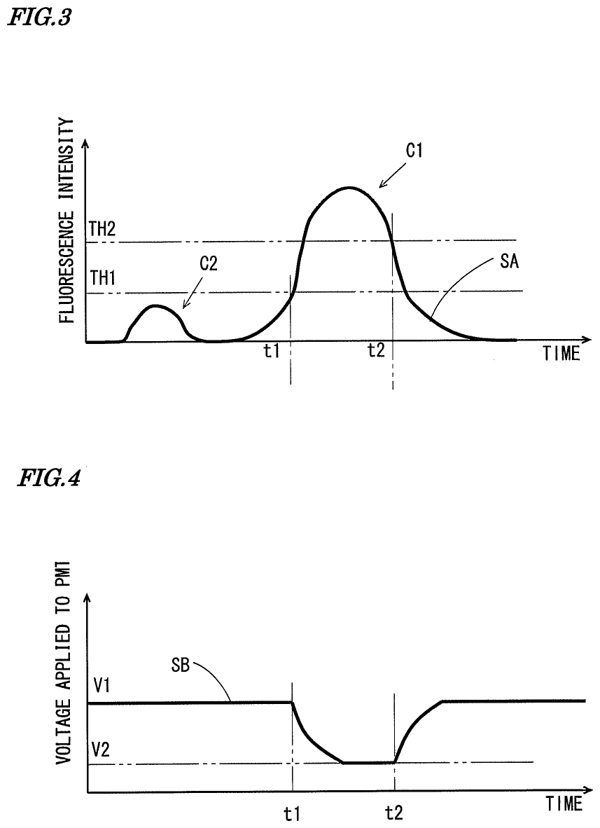

Next, a gain adjustment method according to the present embodiment will be described with reference to FIGS. 3 to 9. A graph SA shown in FIG. 3 indicates a fluorescence intensity input to the photomultiplier tube 63. The graph SA indicates an actual fluorescence intensity of fluorescence generated from a sample in the flow cell 62. The graph SA includes an area C1 indicating high-concentration components included in the sample and an area C2 indicating low-concentration components included in the sample. For example, the area C1 is the detection area for a main component included in the sample, and the area C2 is the detection area for impurities included in the sample.

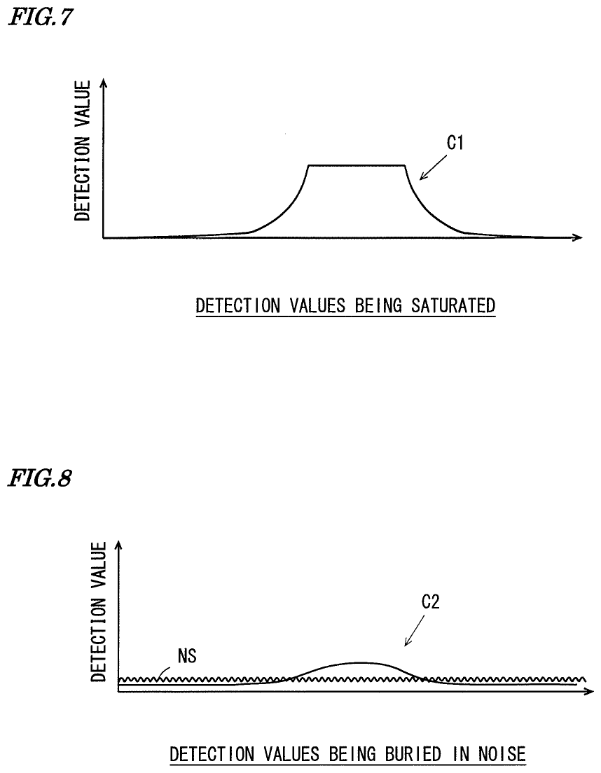

The area C1 is an area indicating high-concentration components, and their fluorescence intensities are high in the area C1. Therefore, as shown in FIG. 7, in a case in which a gain of the photomultiplier tube 63 is large, a detection value of the photomultiplier tube 63 may be saturated around the area C1. The area C2 is an area indicating low-concentration components, and their fluorescence intensities are low in the area C2. Therefore, as shown in FIG. 8, in a case in which a gain of the photomultiplier tube 63 is small, a detection value of the photomultiplier tube 63 may be buried, around the area C2, in a noise NS caused by an electrical system or the like. As such, the gain adjustment device 7 of the present embodiment adjusts a voltage applied to the photomultiplier tube 63 so as to avoid saturation of a detection value and burial of a detection value in a noise.

A graph SB shown in FIG. 4 shows a change of a voltage supplied to the photomultiplier tube 63. That is, the graph SB shows a change of a voltage applied from the power supply 74 to the photomultiplier tube 63. In the present embodiment, the power supply 74 switches between two levels of voltages V1 and V2, and supplies a voltage to the photomultiplier tube 63. The photomultiplier tube 63 maintains a high gain with application of the voltage V1, and reduces a gain with application of the voltage V2. The voltage V1 is a voltage that is set such that low-concentration components are detectable with high sensitivity. The voltage V2 is a voltage that is set such that high-concentration components are detectable without saturation.

In the graph SA shown in FIG. 3, at the fluorescence intensity indicated by TH1, a detection value of the first threshold value TH1 is output in the photomultiplier tube 63. Further, at the fluorescence intensity indicated by TH2, a detection value of the second threshold value TH2 is output in the photomultiplier tube 63.

As shown in the graph SA of FIG. 3, at a point t1 in time, the detection value exceeds the first threshold value TH1. When determining that a detection value received from the acquirer 72 exceeds the first threshold value TH1, the power supply controller 73 instructs the power supply 74 to reduce a voltage. As shown in FIG. 4, at a point in time earlier than the point t1 in time, a voltage applied to the photomultiplier tube 63 by the power supply 74 is V1. When a detection value exceeds the first threshold value TH1, the power supply controller 73 instructs the power supply 74 to reduce a voltage from V1 to V2. A voltage width by which a voltage is to be reduced may be settable by a user.

As shown in FIG. 4, a voltage applied to the photomultiplier tube 63 by the power supply 74 is not instantaneously reduced to the voltage v2 at the point t1 in time. The applied voltage is slowly reduced for a while, and then reduced to the voltage V2. This is because the power supply 74, which is a high-voltage power supply, generally takes time to change an output voltage (a time lag of about 100 milliseconds to 1 second is required, for example.)

As shown in FIG. 3, at a point t2 in time, the detection value drops below the second threshold value TH2. When determining that a detection value received from the acquirer 72 drops below the second threshold value TH2, the power supply controller 73 instructs the power supply 74 to increase a voltage. As shown in FIG. 4, at a point in time later than the point t1 in time, the voltage applied to the photomultiplier tube 63 by the power supply 74 is V2. When a detection value drops below the second threshold value TH2, the power supply controller 73 instructs the power supply 74 to increase a voltage from V2 to V1. A voltage width by which a voltage is to be increased may be settable by the user.

As described above, the power supply 74, which is a high-voltage power supply, generally takes time to change an output voltage. Therefore, a voltage applied to the photomultiplier tube 63 by the power supply 74 is not instantaneously increased to the voltage V1 at the point t2 in time. The applied voltage is slowly increased for a while, and then increased to the voltage V1.

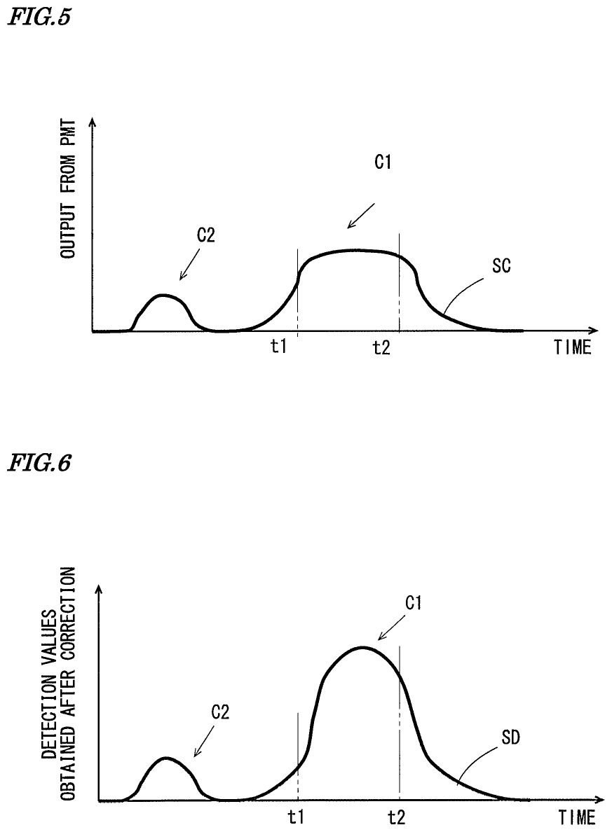

A graph SC shown in FIG. 5 shows a change of a detection value output from the photomultiplier tube 63. As shown by the graph SC, the detection values in the area C1 indicating the high-concentration components are suppressed to be lower than those in the graph SA shown in FIG. 3. This is because, a voltage applied to the photomultiplier tube 63 is reduced to V2 between the point t1 to the point t2 in time, so that a gain of the photomultiplier tube 63 is reduced. Thus, in the area C1 indicating the high-concentration components, although detection values are reduced, saturation of the detection values is avoided.

A graph SD shown in FIG. 6 shows a change of a detection value after correction by the corrector 70. As compared with the graph SC in FIG. 5, it is found that the detection values in the area C1 indicating the high-concentration components are corrected. It is found that, in the graph SD shown in FIG. 6, the shape of the graph SA shown in FIG. 3 can be restored. Because a detection value is corrected by the corrector 70 according to a gain, it is possible to obtain, in a pseudo manner, an output signal similar to that in a case in which a gain is constant.

As shown in FIGS. 3 to 6, in regard to the area C2 indicating low-concentration components included in the sample, the voltage V1 is supplied to the photomultiplier tube 63, so that a correct detection value is obtained. That is, a high gain of the photomultiplier tube 63 is maintained, so that low-concentration components are correctly detected without being buried in a noise. Further, in regard to the area C1 indicating high-concentration components included in the sample, the voltage V2 lower than the voltage V1 is supplied to the photomultiplier tube 63, so that detection values are detected without being saturated. That is, a gain of the photomultiplier tube 63 is reduced, and high-concentration components are detected correctly without being saturated. Because a detection value is not saturated, when an actual gain of the photomultiplier tube 63 is found out, an original fluorescence intensity can be restored by a correction process executed by the corrector 70.

In this manner, the gain adjustment device 7 of the present embodiment corrects a detection value according to a voltage supplied to the photomultiplier tube 63 by the power supply 74. Thus, it is possible to correctly restore a detection value as an original analysis result while changing a gain of the photomultiplier tube 63 during one analysis for a sample. For example, it is considered that, the corrector 70 corrects a detection value based on a point in time at which the power supply controller 73 instructs the power supply 74 to change a voltage. However, in a case in which such a method is used, a time lag is generated in regard to a change of a voltage to be applied from the power supply 74, so that it is not possible to correctly correct a detection value. In the present embodiment, an actual gain of the photomultiplier tube 63 for each moment is estimated in accordance with a change of a voltage actually supplied from the power supply 74 not based on a point in time at which an instruction for changing a voltage is provided by the power supply controller 73, and a detection value is corrected. Therefore, it is possible to correctly correct a detection value.

The gain adjustment device 7 of the present embodiment adjusts a gain of the photomultiplier tube 63 during one analysis for a sample by the high performance liquid chromatograph 1. Thus, even for a sample including high-concentration components and low-concentration components, it is possible to obtain an analysis result with one analysis. Therefore, the dynamic range of the fluorescence detector 6 of the present embodiment can be virtually widened. The conventional measure such as changing a gain and executing two analyses is not necessary, and the efficiency of an analysis process can be improved.

### (5) Other Embodiments

In the above-mentioned embodiment, the acquirer 72 is configured to receive a corrected detection value that is obtained when a detection value is corrected by the corrector 70. In another embodiment, the acquirer 72 may receive a detection value before correction is made by the corrector 70. In this case, the acquirer 72 may be configured to receive an output value from the current-voltage conversion circuit 64. The power supply controller 73 compares a detection value before correction with a threshold value and controls the power supply 74. In this case, it is necessary to set a threshold value corresponding to the detection value before correction.

In the above-mentioned embodiment, two threshold values of the first and second threshold values TH1 and TH2 are used. In another embodiment, a single threshold value TH may be used. In this case, in a case in which a detection value exceeds the threshold value TH, a gain of the photomultiplier tube 63 is simply required to be reduced. In a case in which a detection value drops below the threshold value TH, a gain of the photomultiplier tube 63 is simply required to be increased. However, in a case in which a detection value is increased and reduced in a short period of time due to a noise or the like, a gain is frequently switched. Therefore, it is preferable to use two threshold values as described in the above-mentioned embodiment.

In the above-mentioned embodiment, a high performance liquid chromatograph is used as an analysis device, by way of example. The fluorescence detector 6 and the gain adjustment device 7 of the present embodiment can also be applied to a gas chromatograph, a mass spectrometer using a secondary electron multiplier or a liquid chromatograph of another type.

### (6) Aspects

It will be appreciated by those skilled in the art that the exemplary embodiments described above are illustrative of the following aspects.

(Item 1) An analysis device includes a light source that excites a sample, a photomultiplier tube that detects fluorescence generated from the sample, and a gain adjustment device that adjusts a gain of the photomultiplier tube, wherein the gain adjustment device includes an acquirer that acquires a detection value of fluorescence detected by the photomultiplier tube, a power supply that supplies power to the photomultiplier tube, and a power supply controller that adjusts a gain of the photomultiplier tube during one analysis for the sample by controlling the power supply of the photomultiplier tube in accordance with the detection value acquired by the acquirer.

It is possible to obtain an appropriate measurement result provided by a photomultiplier tube according to the concentration of a component included in a sample.

(Item 2) The analysis device according to item 1, wherein the gain adjustment device may include a corrector that corrects the detection value output from the photomultiplier tube in accordance with a gain of the photomultiplier tube.

Because a detection value is corrected according to a gain of the photomultiplier tube, an appropriate measurement result is obtained.

(Item 3) The analysis device according to item 2, wherein the corrector may include a gain calculator that acquires a voltage value of a voltage supplied by the power supply to the photomultiplier tube and calculates a gain of the photomultiplier tube based on the acquired voltage value.

Because a detection value is corrected based on a voltage supplied from the power supply, an appropriate measurement result is obtained.

(Item 4) The analysis device according to item 1, wherein the power supply controller may provide an instruction for reducing a gain of the photomultiplier tube to the power supply when the detection value acquired by the acquirer exceeds a first threshold value, and may provide an instruction for increasing a gain of the photomultiplier tube when the detection value acquired by the acquirer is lower than a second threshold value.

Frequent change of a voltage in a case in which a detection value varies can be avoided.

(Item 5) The analysis device according to item 2, wherein the acquirer may acquire a corrected detection value that is obtained when a detection value is corrected by the corrector.

It is possible to adjust a gain according to a concentration based on a corrected detection value.

(Item 6) The analysis device according to item 1, wherein a sample having a fluorescence emission property may be irradiated with excitation light, and the photomultiplier tube may detect generated fluorescence.

A gain is adjusted appropriately according to an intensity of fluorescence generated from a sample.

(Item 7) The analysis device according to item 1, wherein the gain adjustment device may adjust a gain of the photomultiplier tube included in a fluorescence detector.

It is possible to detect a component with high sensitivity.

(Item 8) A gain adjustment device according to another aspect that adjusts a gain of a photomultiplier tube, includes an acquirer that acquires a detection value provided by the photomultiplier tube, a power supply that supplies power to the photomultiplier tube, and a power supply controller that adjusts a gain of the photomultiplier tube in one analysis for a sample by controlling the power supply in accordance with the detection value acquired by the acquirer.

It is possible to obtain an appropriate measurement result provided by a photomultiplier tube according to the concentration of a component included in a sample.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. An analysis device comprising:
a light source that excites a sample;
a photomultiplier tube that detects fluorescence generated from the sample; and
a gain adjustment device that adjusts a gain of the photomultiplier tube, wherein
the gain adjustment device includes
an acquirer that acquires a detection value of fluorescence detected by the photomultiplier tube,
a power supply that supplies power to the photomultiplier tube, and
a power supply controller that adjusts a gain of the photomultiplier tube during one analysis for the sample by controlling the power supply of the photomultiplier tube in accordance with the detection value acquired by the acquirer.

2. The analysis device according to claim 1, wherein
the gain adjustment device includes a corrector that corrects the detection value output from the photomultiplier tube in accordance with a gain of the photomultiplier tube.

3. The analysis device according to claim 2, wherein
the corrector includes a gain calculator that acquires a voltage value of a voltage supplied by the power supply to the photomultiplier tube and calculates a gain of the photomultiplier tube based on the acquired voltage value.

4. The analysis device according to claim 1, wherein
the power supply controller provides an instruction for reducing a gain of the photomultiplier tube to the power supply when the detection value acquired by the acquirer exceeds a first threshold value, and provides an instruction for increasing a gain of the photomultiplier tube when the detection value acquired by the acquirer drops below a second threshold value.

5. The analysis device according to claim 2, wherein
the acquirer acquires a corrected detection value that is obtained when a detection value is corrected by the corrector.

6. The analysis device according to claim 1, wherein
a sample having a fluorescence emission property is irradiated with excitation light, and the photomultiplier tube detects generated fluorescence.

7. The analysis device according to claim 1, wherein
the gain adjustment device adjusts a gain of the photomultiplier tube included in a fluorescence detector.

8. A gain adjustment device that adjusts a gain of a photomultiplier tube, including:
an acquirer that acquires a detection value provided by the photomultiplier tube;
a power supply that supplies power to the photomultiplier tube; and
a power supply controller that adjusts a gain of the photomultiplier tube in one analysis for a sample by controlling the power supply in accordance with the detection value acquired by the acquirer.
